(19) United States
(12) Patent Application Publication
(10) Pub. No.: US 2014/0223666 A1
(43) Pub. Date: Aug. 14, 2014

(54) SKIN IRRITANT REDUCTION CUSHIONING CONSTRUCTION

(71) Applicant: David R. Pavlin, Springfield, MO (US)

(72) Inventor: David R. Pavlin, Springfield, MO (US)

(21) Appl. No.: 14/170,414

(22) Filed: Jan. 31, 2014

Related U.S. Application Data
(60) Provisional application No. 61/849,718, filed on Feb. 4, 2013.
(60) Provisional application No. 61/854,703, filed on Apr. 29, 2013.

(51) Int. Cl. A61G 7/057; A47C 27/15; A61G 5/10

(52) U.S. Cl. CPC A61G 7/057; A61G 5/10; A47C 27/15
USPC 5/727; 297/229; 297/228; 297/250.1; 5/690; 5/739

(57) ABSTRACT

Cushioning constructions for mattresses or chair cushions are given comfort features for severely immobilized patients. Otherwise, the problem is that, sit or lie still long enough and awful sores may develop. The cushioning constructions hereof are formed of plural or multiple layers of resilient materials of dissimilar softness/firmness and, moreover, these layers are partitioned into multiple zones across the layers of likewise dissimilar softness/firmness. Such features include soft sinking spots for the pelvic area in mattresses or for the counterpart ischium support zone in seat cushions. In distinction, firm and soft juxtapositions are provided for the upper thigh region in mattresses or in the counterpart femoral support zone in seat cushions. Conversely, firm lateral rails for mattresses or counterpart lateral wings for cushions of chair backs are provided where the concern is with Huntingdon's disease patients, who are largely immobile but periodically convulse at times.

### CROSS-REFERENCE TO PROVISIONAL APPLICATION(S)

This application claims the benefit of U.S. Provisional Application No. 61/849,718, accorded filing date Feb. 4, 2013; and U.S. Provisional Application No. 61/854,703, accorded filing date Apr. 29, 2013, the disclosures of which are incorporated herein by this reference thereto.

### BACKGROUND AND SUMMARY OF THE INVENTION

The invention relates to medical cushioning constructions for bed mattresses and chair cushions or the like. More particularly, the invention relates to medical cushioning constructions for redistributing the pressure that supports the occupying patient. The severest of these kinds of patients are typically so physically infirm that their frailty has mostly confined them to a static, essentially immobile existence in chairs or beds. Additionally, the invention relates to reducing the irritation of skin wounds and/or ulcerations caused by such an existence.

Moreover, the medical cushioning constructions in accordance with the invention chair cushion and bed mattress designs in accordance with the invention provide advantages not only for severely infirm patients (who sit or lie almost stationary for endless stretches of time), but also for patients suffering from Huntingdon's disease or the like, which makes the patient periodically convulse at times.

‘Patients’ such as these can be ‘patients’ in their own home, but typically with some attendant on hand or available to help with feeding and cleaning as well as with other chores.

For patients such as these, skin wounds typically start with sitting. For example, there is a value for a pressure known in the industry that, when sitting, the typical person develops about 600 mm Hg of pressure that is crushing his or her capillaries. Sit long enough, and blood flow will be altered at the most pressurized areas.

It is an object of the invention to design medical cushioning constructions with special features for pressure redistribution and skin wound care.

When referring to foam cushioning material, there is an industry property (or rating, and it may be unfamiliar to most of the public) which places a value on the relative firmness and/or softness of a foam. This rating is known as the Indentation (or Impression) Force Deflection rating (ie., IFD rating). Decades ago, the IFD rating was supposed to be the metric system replacement (ie., in Newtons and centimeters) of the older Indentation Load Deflection rating (eg., ILD, which was described in pounds and inches).

In spite of the drive for metric system conversion back then, Industry perhaps has forsaken metric units in favor of retention of English units. The test procedure for all this has a similar acronym and it therefore causes slight confusion with the IFD or ILD rating (and this being, the Indentation Residual Deflection Force, or IRDF procedure). According to the “Glossary” of the Polyurethane Foam Association's Joint Industry Foam Standards And Guidelines:—
Indentation Force Deflection (IFD)—A measure of the load bearing capacity of flexible polyurethane foam. IFD is generally measured as the force (in pounds) required to compress a 50 square inch circular indentor foot [ie., ^{˜}8.00 inch OD] into a four inch thick sample no smaller than 24 inches square [ie., presumably, at least a four square-foot square panel 4 inches thick], to a stated percentage of the sample's initial height. Common IFD values are generated at 25 and 65 percent of initial height [ie., 3 inches thick or 1.4 inches thick, respectively, wherein—evidently—the 25% deflection standard is the more common rating standard]. Reference Test Method ASTM D3574.
Indentation Load Deflection (ILD)—See Indentation Force Deflection.
Indentation Modulus—IM=(40% IFD−20% IFD)/20% IFD. The force required to produce an additional 1% indentation between the limits of 20% IFD and 40% IFD determined without the one minute rest. The slope of this line represents the resistance of the cell struts to post buckling. The slope of the linear portion of the stress-strain curve is defined as the indentation modulus.
Indentation Residual Deflection Force (IRDF)—A test method used with seating foam to determine how thick the padding is under the average person. The amount of deflection is determined by measuring the thickness of the pad under fixed force of 4.5 Newtons, 110 N, and 220 N [ie., ^{˜}1.00, ^{˜}25 and ^{˜}50 lbs, respectively] on a 323 square centimeter circular indentor foot [ie., ^{˜}8.00 inch OD].

(Section 15.0, published July 1994) (accessed online Apr. 29, 2013 at http://www.pfa.org/jifsg/jifsgs15.html).

The preferred acronym (and a specified deflection therefor) is the Indentation Force Deflection (IFD) rating at twenty-five percent (25%) deflection. The following is a passage taken from Section 4.0 of the Polyurethane Foam Association's Joint Industry Foam Standards And Guidelines:—

INDENTATION FORCE DEFLECTION (IFD)
STANDARDS AND GUIDELINES

| | |
|---|---|
| 4.1 | To the furniture manufacturer and final user of a piece of |
| | furniture, one of the most important quality questions is |
| | related to the firmness of the seat cushions. The firmness of |
| | a polyurethane foam cushion is measured by a physical |
| | property called the indentation force deflection (IFD). |
| 4.1.1 | The history of describing firmness is very interesting. Prior to |
| | the advent of polyurethane foams, rubber latex foams were in |
| | wide use for furniture cushions. The term used to describe the |
| | firmness or softness of foam rubber was RMA, which stood |
| | for Rubber Manufacturers Association. RMA was measured |
| | only slightly different from the way IFD is measured today. |
| 4.1.2 | When polyurethane foams arrived on the scene, they weren't |
| | associated with the rubber industry, so the acronym “ILD” |
| | was developed. “ILD” stood for “indentation load deflection.” |
| | During the drive for conversion to the metric system in the |
| | late seventies, the American Society of Testing and Materials |
| | (ASTM) decided that in all of their publications and test |
| | methods, the metric system would be used. Because the ASTM |
| | insisted on the use of the word “force” rather than “load,” the |
| | term “IFD” came into common use--replacing “ILD.” IFD |
| | stands for “Indentation Force Deflection” and the actual test |
| | method is basically identical to the older ILD test. |
| 4.2.1 | In this publication, The Joint Industry Committee has purposely |
| | avoided using the word “comfort” directly associated with |
| | IFD or IFD properties. Suffice to say, IFD is a part of the |
| | comfort equation, but IFD is not always related directly to |
| | comfort. For example, one cannot say that a 25% IFD of 26 |
| | lbs/50 in² always produces comfort, while a 25% IFD of 40 |
| | lbs/50 in² does not produce a comfortable seat. Comfort is not |
| | directly related to the magnitude of the IFD number alone. |
| 4.2.2 | IFD is defined as the amount of force, in pounds, required to |
| | indent a fifty square inch, round indentor foot into a |
| | predefined foam specimen a certain percentage of the |
| | specimen's total thickness. IFD should always be specified as |
| | a number of pounds at a specific deflection percentage on a |
| | specific height foam sample, e.g., 25 pounds/50 insq. at a |
| | 25% deflection on a four inch thick piece. Different IFD |
| | values will be obtained if a different percentage deflection is |
| | used or if the height of the test specimen is different. It is also |
| | necessary to report the entire sample size. Sample size, in |
| | addition to thickness, can drastically influence IFD readings. |
| | Flexible polyurethane foams can be made in a very wide |
| | range of IFD's. To get a good feeling of the potential uses of |
| | each of the various IFD ranges, the following chart should be |
| | of some assistance: |

IFD @25% DEFLECTION USE (pounds/50 insq. on 20″ × 20″ × 4″)

| | |
|---|---|
| 6-12 | Bed pillows, thick back pillows |
| 12-18 | back pillows, upholstery padding, wraps |
| 18-24 | thin back pillows, tufting matrix, very thick seat cushions, wraps |
| 24-30 | average seat cushions, upholstery padding, tight seats, |
| | certain mattress types, quilting |
| 30-36 | firmer seat cushions, mattresses |
| 36-45 | thin seat cushioning and firm mattresses |
| 45 | shock absorbing foams, packaging foams, carpet pads, and |
| and up | other uses requiring ultra-firm foams. |

The above table should only be used as a beginning guideline. The actual IFD required is a function of many things, . . .
(Section 4.0, published: July 1994) (accessed online April 29 of 2013 at http://www.pfa.org/jifsg/jifsgs4.html).

Accordingly, it is an object of the invention to design cushioning constructions with varying zones and layers of properties specially for skin wound care, including any of varying IFD ratings, varying densities, varying airflow-ventilation capacity, and so on.

A number of additional features and objects will be apparent in connection with the following discussion of the preferred embodiments and examples with reference to the drawings.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the skills of a person having ordinary skill in the art to which the invention pertains. In the drawings,

FIG. 1A is a perspective view of a first embodiment of a cushioning construction in accordance with the invention, as adapted for draping over a chair that has armrests;

FIG. 1B is a perspective view comparable to FIG. 1A except with the encasement member for the cushioning construction in accordance with the invention removed from view;

FIG. 2 is an exploded perspective view of FIG. 1B;

FIG. 3 is an enlarged scale perspective view of the seat support section and lower limb support section thereof;

FIG. 4 is an enlarged-scale section view taken along line IV-IV in FIG. 3;

FIG. 5 is an enlarged scale perspective view comparable to FIG. 1B except with the chair, the encasement member and right-side assembly of flexibly-linked slats removed from view;

FIG. 6 is a perspective view of a second embodiment of a cushioning construction in accordance with the invention, and as likewise adapted for draping over a chair;

FIG. 7 is an exploded perspective view of FIG. 6;

FIG. 8 is an enlarged scale perspective view of the head support section thereof;

FIG. 9 is an enlarged scale perspective view of the lower limb support section thereof;

FIG. 10 is an enlarged scale perspective view of the seat support section thereof;

FIG. 11 is an enlarged scale perspective view of the back support thereof, and with the hip support portions partly exploded from major portions of the two outer vertically-elongated blocks of the back portion (wherein the position of the hip support portions when assembled are shown in dashed line);

FIG. 12 is a perspective view of a third embodiment of a cushioning construction in accordance with the invention, as adapted to serve as a bed mattress, and with only a portion of the encasement member therefor shown in solid line;

FIG. 13 is perspective view comparable to FIG. 12 except with a rigid sub-base and head and foot boards removed from view;

FIG. 14 is an exploded perspective view of FIG. 13 showing the longitudinal separation of the upper body support zone, the intermediate pelvic-and-upper thigh support zone and the lower extremity support zone (which three zones form the core assembly for the mattress), as well as the vertical separation of the underlying base layer and the lateral separation of a pair of flanking side rails;

FIG. 15 is a perspective view comparable to FIG. 14 except of the side rails in isolation;

FIG. 16 is a perspective view comparable to FIG. 14 except of the upper body support zone in isolation;

FIG. 17 is a perspective view comparable to FIG. 14 except of the pelvic-and-upper thigh support zone in isolation, and with the upper and lower layers thereof exploded;

FIG. 18 is a perspective view comparable to FIG. 14 except of the lower extremity support zone in isolation;

FIG. 19 is an enlarged-scale section view taken along the line XIX-XIX in FIG. 18;

FIG. 20 is a perspective view comparable to FIG. 14 except of the base layer in isolation;

FIG. 21 is a perspective view, partly exploded, of a fourth embodiment of a cushioning construction in accordance with the invention, except with the encasement member and right-side assembly of flexibly-linked slats not shown in the view, and which fourth embodiment is adapted for draping over a chair with armrests (chair not shown); and

FIG. 22 is an enlarged scale perspective view of the ABS base in FIG. 20.

### DETAILED DESCRIPTION OF THE PREFERRED EMBODIMENTS

The drawings show various cushioning constructions 101-104 in accordance with the invention for mattresses or chair cushions. These cushioning constructions 101-104 are given comfort features for severely immobilized patients. Otherwise, the problem is that, sit or lie still long enough and awful sores may develop. The cushioning constructions 101-104 hereof are generally designed in accordance with a general plan as follows. That is, the cushioning constructions 101-104 hereof are typically formed with plural or multiple layers of resilient materials of dissimilar softness/firmness and, moreover, these layers are partitioned into multiple zones across the layers of likewise dissimilar softness/firmness. Such features include without limitation soft sinking spots 262 for the pelvic area in mattresses or for the counterpart ischium support zone 184 in seat cushions. In distinction to just soft only sinking spots, firm and soft juxtapositions are provided elsewhere, such as for the upper thigh region 266 vs. 268 in mattresses or in the counterpart femoral support zone 182 vs. 188 in seat cushions. Conversely, firm lateral rails 258 for mattresses or counterpart lateral wings 116 for cushions of chair backs are provided where the concern is with Huntingdon's disease patients, who are largely immobile but periodically convulse at times.

The drawings are labeled with the indications of the non-exclusively preferred design choices for material selection in connection with the various components of the inventive cushioning constructions 101-104. The following serves as a key in part to deciphering those indications.

Foam material selection and foam IFD ratings therefor are sometimes indicated in the manner of “F1832” or “F1845” where, the “F” portion of the designation corresponds to fire retardant foam, the first two numerals of the designation (ie., “18”) correspond to the density of the foam in tenths of pounds (lbs) per cubic foot (ie., 1.8 pounds per cubic foot), and the last two numerals (eg., “32” and “45”) correspond to the IFD rating number. Preferably the “32” and “45” should be interpreted as counterpart to another Industry way of stating such a specification, namely, 25% IFD of 32 lbs/50 insq. and 25% IFD of 45 lbs/50 insq., respectively.

Moreover, many of the broad surfaces of the foam panels (which are usually oriented up or towards the patient occupant of the mattress or chair) include recessed airflow channels formed therein for enhanced capacity of airflow ventilation therein (as either by convection and/or forced flow). In this instance, convection predominantly is likely largely to be a product of natural convection, and forced flow is likely largely to be a product of patient or care-giver deformation of the cushioning construction in accordance with the invention. In other words, when the patient rolls on his or her mattress, he or she is going to the foam to exhale air in some spots and inhale at others.

The recess features include without limitation swirly channels recessed into some broad surface, or laterally extending recessed corrugations or channels in other broad surfaces, and so on.

Foam material selection and foam IFD ratings therefor are other times indicated in the manner of “RW12” where, the “RW” portion of the designation corresponds to 1.5 pound per cubic foot density and the numeric portion of the designation (eg., “12”) corresponds to the IFD rating number. Preferably the “12” should be interpreted as counterpart to another Industry way of stating such a specification, namely, 25% IFD of 12 lbs/50 insq.

A further way of indication foam material selection and foam IFD ratings therefor include the manner of with the new introduction of the “RP(number)” designation (eg., “RP30” or “RP40”), wherein the “RP” portion of the designation corresponds to 1.45 pound per cubic foot density and the numeric portion of the designation (eg., “30” or “40”) corresponds to the IFD rating number. Preferably the “30” and “40” should be interpreted as counterpart to another Industry way of stating such a specification, namely, 25% IFD of 30 lbs/50 insq. and 25% IFD of 40 lbs/50 insq., respectively.

Moreover, the “2.5 lb visco” designation indicates viscoelastic or ‘memory’ foam that has a density 2.5 pounds per cubic feet and a compression rating (ie., IFD rating) of 10 pounds or so (in other words, very light pressure compresses it).

ABS is the acronym that designates a known plastic material, namely, acrylonitrile-butadiene-styrene. More significantly, it is a rigid (in contrast to resilient) polymeric or synthetic material. (It is preferred to stick with suitable polymeric or synthetic materials given the medical use application of the cushioning constructions in accordance with the invention).

In the mattress embodiment 104 of cushioning constructions 101-104 in accordance with the invention, the top broad surface of the upper layer 213 of the lower extremity support zone 256 is striated into a cubic grillwork lattice of airflow channels formed therein, and in contrast to swirly convolute or corrugated/channel-shaped airflow recesses 158 shown elsewhere. The preferred IFD rating for the top layer 213 of foam is 12 lbs for a 50 insq. circular indentor foot (ie., ^{˜}8.00 inch OD) to sink into four inch thick sample no smaller than 24 inches square by an inch (ie., 25%). In other words, such an IFD rating of 12 is very soft. The cubic grillwork lattice probably serves more to reduce the actual IFD rating to an even lower apparent IFD rating, given the frictional slipping among cubes of the cubic grillwork lattice (in the upper layer 213).

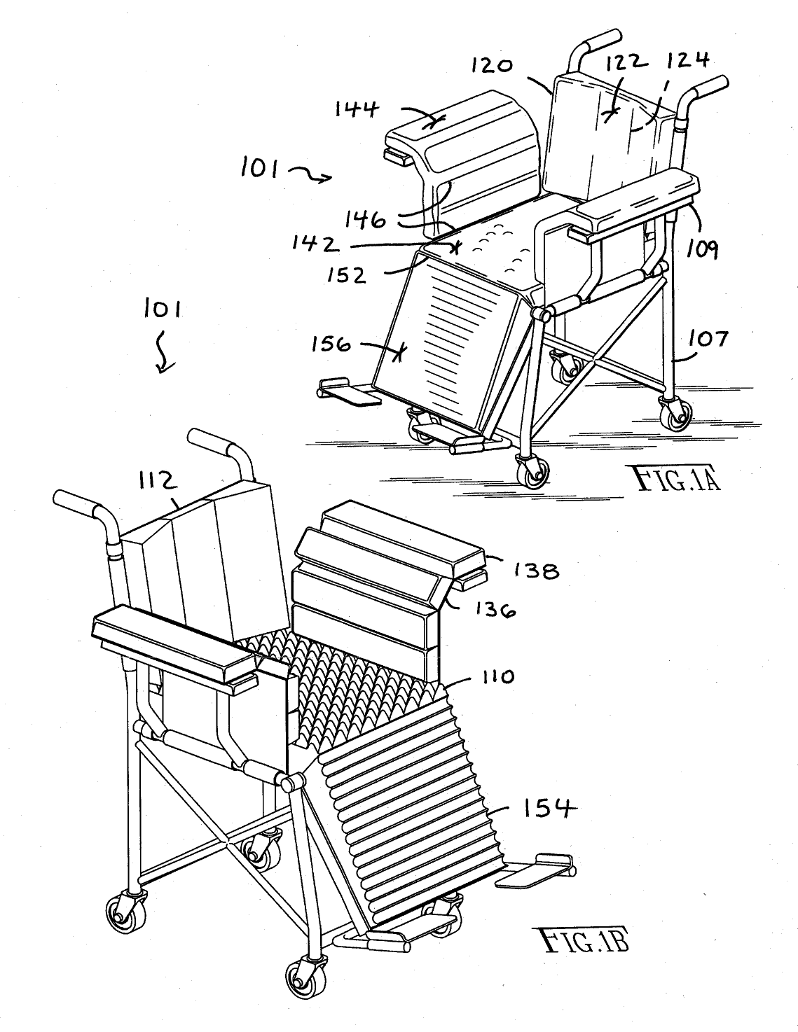

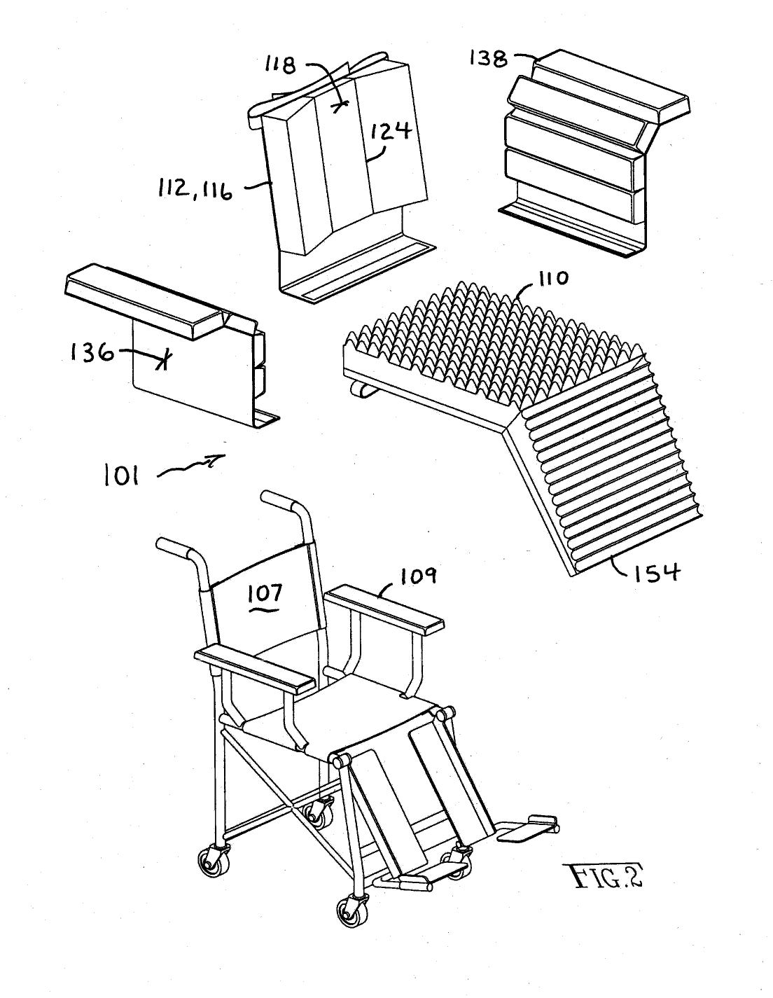

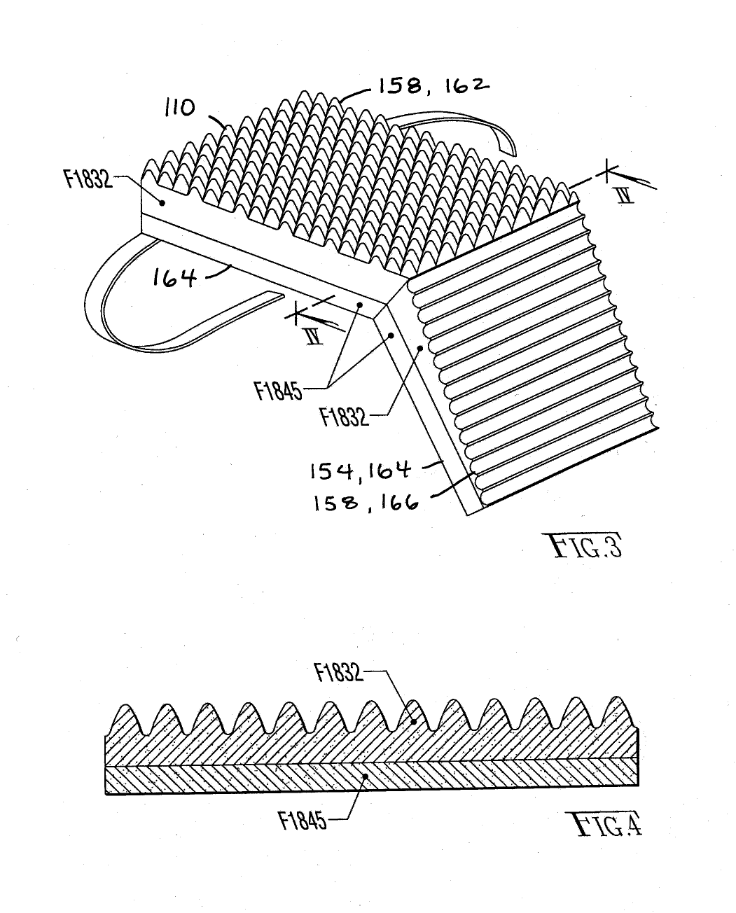

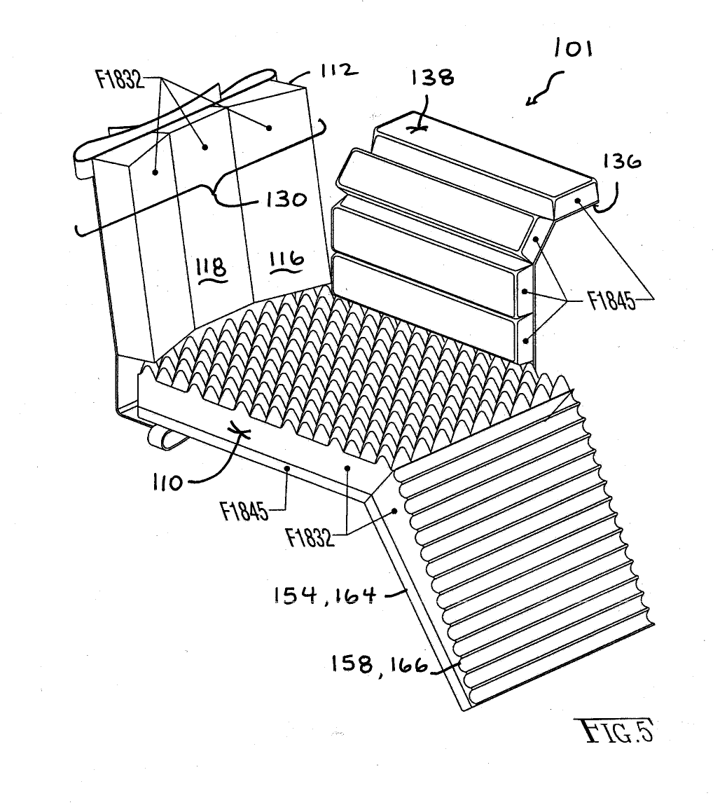

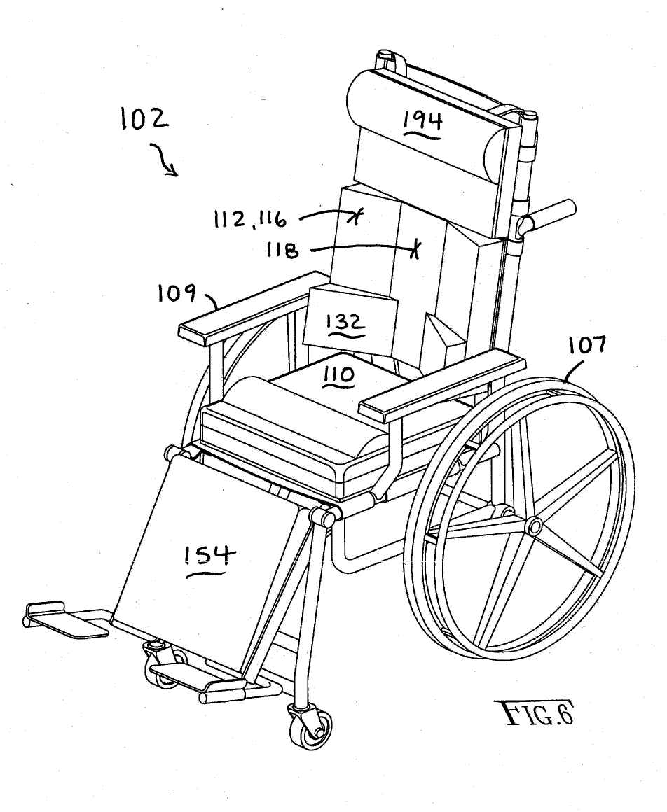

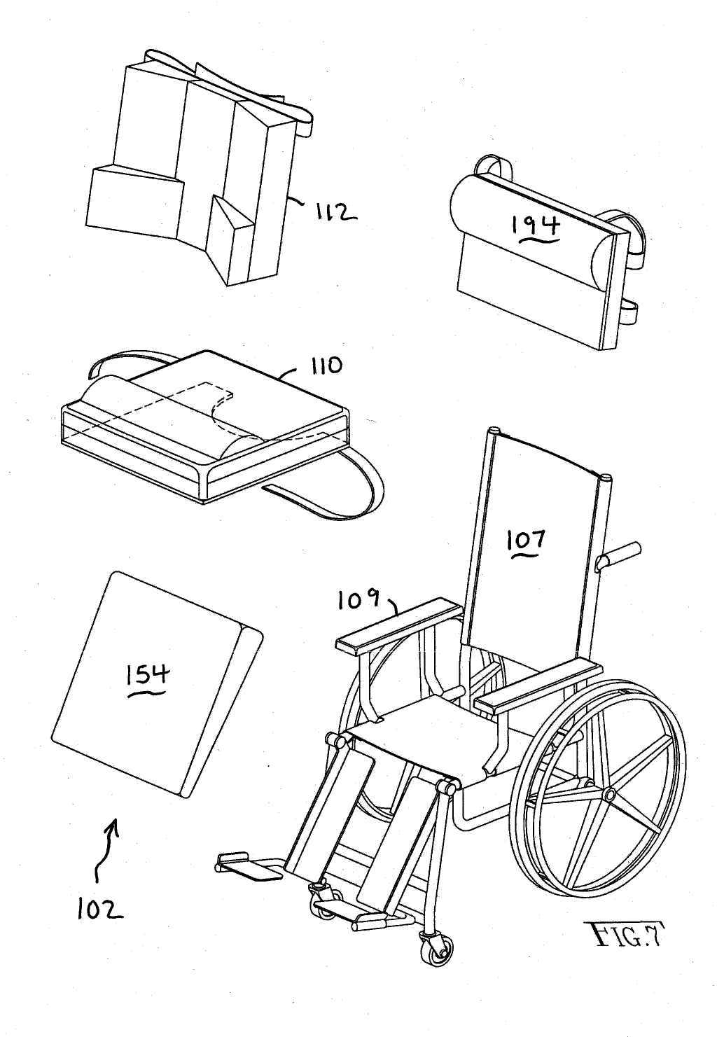

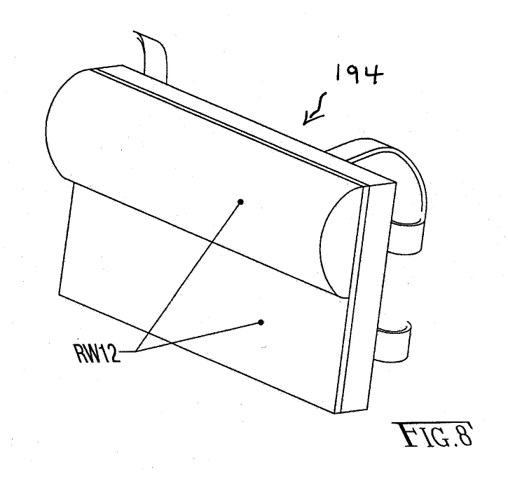

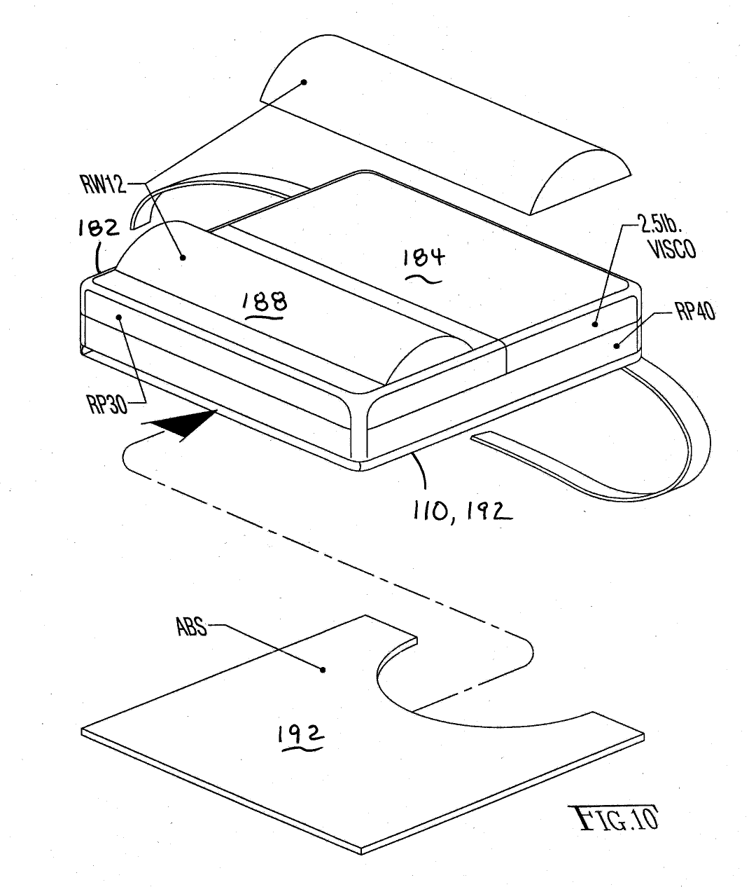

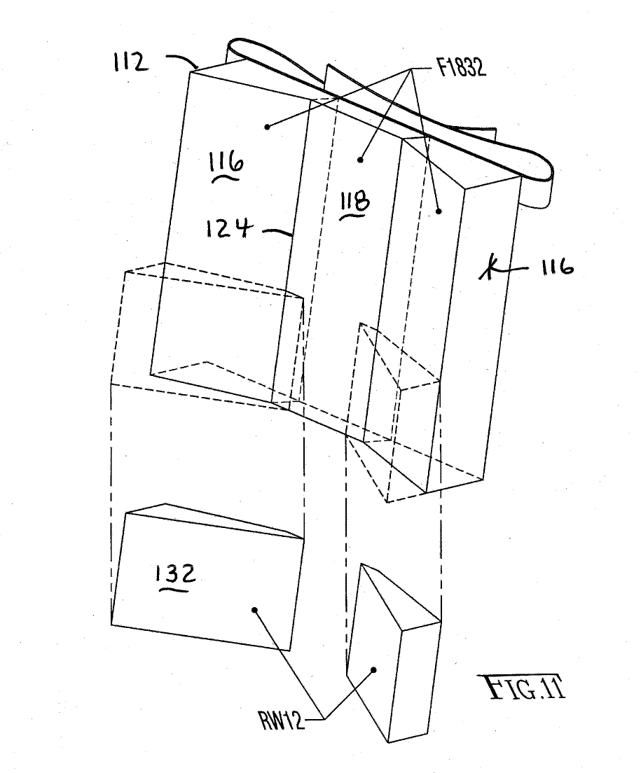

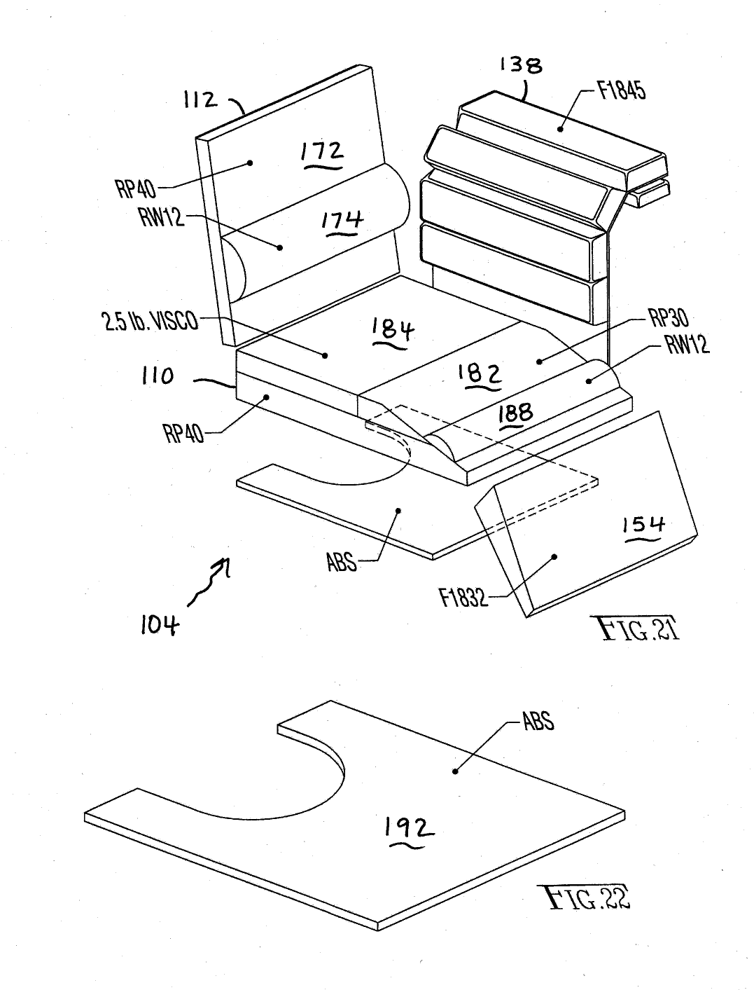

FIGS. 1A through 11 and then also FIGS. 21 and 22 show a first, second and fourth embodiment 101, 102 and 104 of cushioning constructions in accordance with the invention that are more particularly adapted for draping over chairs 107. For the first and fourth embodiments 101 and 104, armrest-flaps 144 are included for furthermore draping over any armrests 109 of the chairs 107.

These cushioning constructions 101, 102 and 104 are typically characterized by a seat support section 110 comprising a resilient material formed in a generally rectangular outline, and, a back support section 112 comprising a resilient material formed in a generally rectangular outline.

For the first and second embodiments 101 and 102, the back support section 112 is formed by at least two outer vertically-elongated blocks 116 of resilient material and at least one inner vertically-elongated block 118 of resilient material medial of the at least two outer blocks 116. There is also a flexible encasement member 120 for the back support section 112 configured with at least one pocket 122 adapted for receiving the at least two outer blocks 116 and also the at least one inner vertically elongated block 118. The flexible encasement member 120 further comprises vertically-elongated seams 124 intermediate the blocks 116,118 which not only serve to stabilize positions among the blocks 116,118 but also define articulation axes between adjacent blocks 116,118 whereby the blocks 116,118 can articulate relative to each other about the axes.

Preferably the blocks 116,118 of the back support section 112 are cooperatively formed to form a shallow, vertically-extending channel shape 130 into the depth of the back support section 112. That way, the at least one inner block 118 is adapted to serve as a spinal support block for the seat occupant as the at least two outer blocks 116 are adapted to provide moderately enveloping lateral wings (ie., 116) to support the torso of the seat occupant.

In the second embodiment 102, the at least two outer vertically-elongated blocks 116 of resilient material are preferably formed as composites of a major portion (ie., 116) of one resilient material having one set of properties, and then also include a hip support portion 132 of another resilient material having a another set of properties. The hip support portions 132 of the other resilient material for both the at least two outer vertically-elongated blocks 116 are located down low in the back support section 112 and flanking the seat occupant's hips. It is a preferred aspect of the invention that the other resilient foam material of the hip support portions 132 are softer (substantially softer) than the one resilient foam material of the major portions 116.

The first and fourth embodiments 101 and 104 are further characterized by having a left and a right flexible linking substrate 136, and then also, a left-side and a right-side plurality of longitudinally-elongated slats 138 of resilient materials flexibly linked together by the left and right flexible linking substrates 136, respectively. These plurality of longitudinally-elongated slats 138 for each side of the respective cushioning construction 102 are thereby adapted to form a roll over the chair 107's left and right armrests 109, respectively.

It is preferred to provide a flexible encasement member 120 for both the seat support section 110 and the left-side and right-side plurality of longitudinally-elongated slats 138 (which as soon to be described below, form “flaps”). More particularly, the flexible encasement member 120 is configured with a seat support-section pocket 142 adapted for receiving the seat support section 110, and, then also with a left-side flap 144 and a right-side flap 144. Each flap 144 is configured with a pocket adapted for receiving the left-side and right-side plurality of longitudinally-elongated slats 138, respectively.

Moreover, the flexible encasement member 120 further comprises a series of longitudinally-extending seams 146 intermediate the pockets 142 and 144. These seams 146 not only serve as partitions between the pockets 142 and 144 for the seat support section 110 (as well as the left-side and right-side flaps 144) but also define longitudinally-extending articulation axes therebetween such that the flaps 144 and seat support section 110 can articulate relative to each other.

It is a further preferred aspect of the invention if the flexible encasement member 120 is further configured with a back support-section pocket 122 adapted for receiving the back support section 112. Thus, the flexible encasement member 120 would further comprise a laterally-extending seam 152 intermediate the seat support-section pocket 142 and the back support-section pocket 122. This laterally-extending seam 152 not only serves as a partition between the pockets 142 and 122 for the seat support section 110 and the back support section 112 but also defines a laterally-extending articulation axis therebetween whereby said support sections 110 and 112 can articulate relative to each other about said laterally-extending articulation axis.

The first, second and fourth embodiments 101, 102 and 104 each include a lower limb support section 154 comprising a resilient material formed in a generally rectangular outline. Preferably the flexible encasement member 120 is further configured with a lower limb support-section pocket 156 adapted for receiving the lower limb support section 154. The flexible encasement member 120 would have a second laterally-extending seam 152 intermediate the seat support-section pocket 142 and the lower limb support-section pocket 156. That way, the second laterally-extending seam 152 not only serves as a partition in part between the pockets 142 and 156 for the seat support section 110 and the lower limb support section 154 but also defines a second laterally-extending articulation axis therebetween, whereby said support sections 110 and 154 can articulate relative to each other about said second laterally-extending articulation axis.

It is a preference of the invention if the upper surfaces of the seat support section 110 and the lower limb support 154 (and underneath the cover of the encasement member 120) are configured with (or scored with) at least laterally-trending, air ventilation channels 158.

Preferably the lower limb support section 154 comprises a block of resilient material at least wedge-shaped in part, and extending longitudinally between a proximal end proximate the seat support section 110 and a spaced away distal end. Thus, the lower limb support section 154 generally tapers thinner from the proximal end, which is relatively thicker, to the distal end, which is relatively thinner.

Overall, the flexible encasement member 120 for all of seat support section 110, the back support section 112, and the lower limb support section 154 is configured with a back support-section pocket 122 adapted for receiving the back support section 112, a seat support-section pocket 142 adapted for receiving the seat support section 110, and a lower limb support-section pocket 156 adapted for receiving the lower limb support section 154. The flexible encasement member 120 would further comprise laterally-extending seams 152 intermediate the pockets 122, 142 and 156 at least in part. Thus, the laterally-extending seams 152 not only serve as partitions in part between the pockets 122, 142 and 156 for the support sections 112, 110 and 154 but also define laterally-extending articulation axes therebetween whereby said support sections 112, 110 and 154 can articulate relative to each other about said laterally-extending articulation axes.

It is a design preference that the seat support section 110 comprises a seat-section upper layer 162 of resilient material and an underlying lower layer 164 of resilient material underneath the seat-section upper layer 162. Likewise (at least for the first embodiment 101), the lower limb support section 154 comprises a lower-limb section upper layer 166 of resilient material and a continuation of the lower layer 164 of resilient material for the seat-section upper layer 162, underlying and underneath the lower limb-section upper layer 166. It is an aspect of the invention that this lower layer 164 is firmer than both the aforementioned upper layers 162 and 166.

For the fourth embodiment 104, it is preferred if the back support section 112 comprises at least one block 172 of one resilient material (or plural blocks 116 and 118 of plural resilient materials) form a generally rectangular outline for a major part (ie., 172 or 116/118) of said back support section 112. It is further preferred to give the back support section 112 a lumbar support cushion 174 of another resilient material arranged on the occupant-side outside of the at least one block 172 or all blocks 116/118 of the one or plural resilient materials that form the generally rectangular outline for the major part (ie., 172 or 116/119) of said back support section 112. It is another aspect of the invention that the lumbar support cushion 174 is softer (much softer) than any of the blocks 172 or 116/118 of the major part (ie., 172 or 116/118) of the back support section 112.

To turn to particulars of the seat support section 110, it comprises an upper layer 162 of resilient material and an underlying lower layer 164 of resilient material underneath the upper layer 162. Preferably the lower layer 164 is firmer than the upper layer 162. In the second and fourth embodiment 102 and 104, upper layer 162 is partitioned into longitudinal zones comprising a forward femoral support zone 182 of non-viscoelastic memory foam and a rearward ischium support zone 184 of viscoelastic memory foam. The forward femoral support zone 182 further comprises a low-rising, laterally-extending femoral support cushion 188 of another resilient material. Wherein, the forward femoral support zone 182 is firmer than the low-rising, laterally-extending femoral support cushion 188.

In the fourth embodiment 104, the forward femoral support zone 182 comprises a block of resilient material at least wedge-shaped in part, and extending longitudinally between a proximal end proximate the ischium support zone 184 and a spaced away distal end. That is, said forward femoral support zone 182 generally tapers thinner from the proximal end, which is relatively thicker, to the distal end, which is relatively thinner. Additionally, the seat support section 110 further comprises a base layer 192 of a rigid material, underlying and underneath the lower layer 164 of resilient material for the seat support section 110. Preferably this base layer 192 comprises ABS or some other suitable polymeric and/or synthetic material.

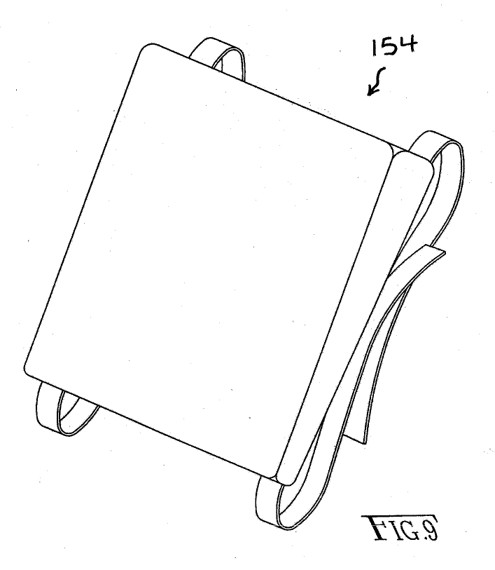

The second embodiment 102 furthermore includes a head support section 194, as better shown by FIG. 8.

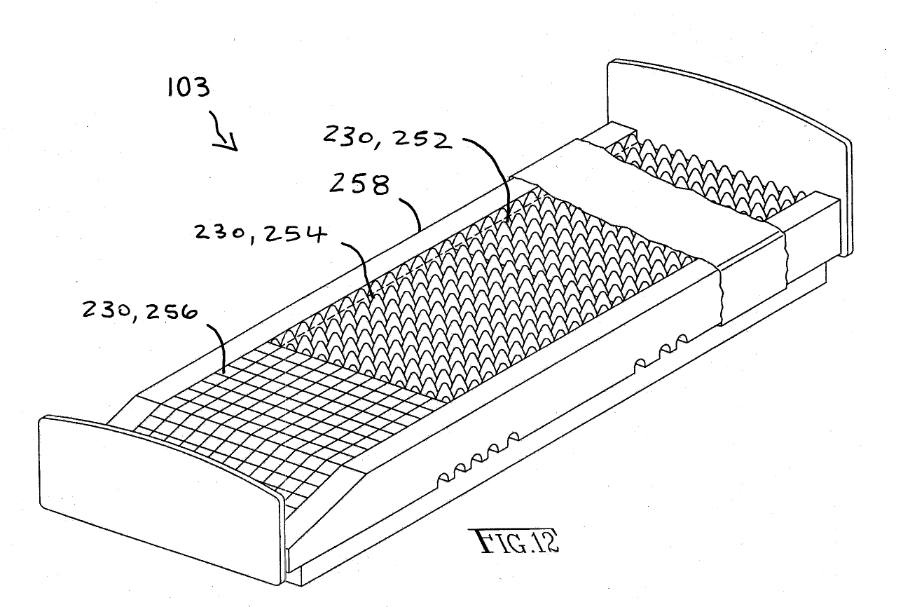

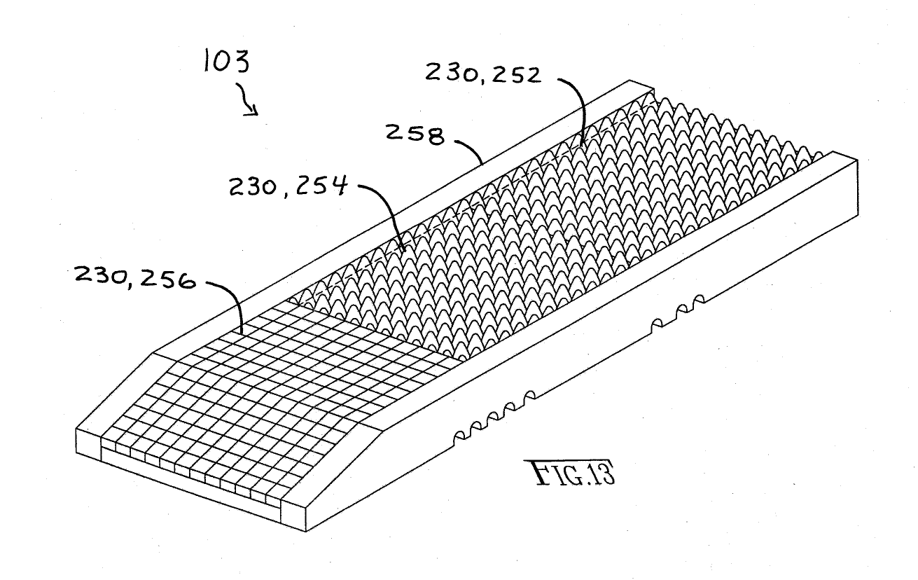

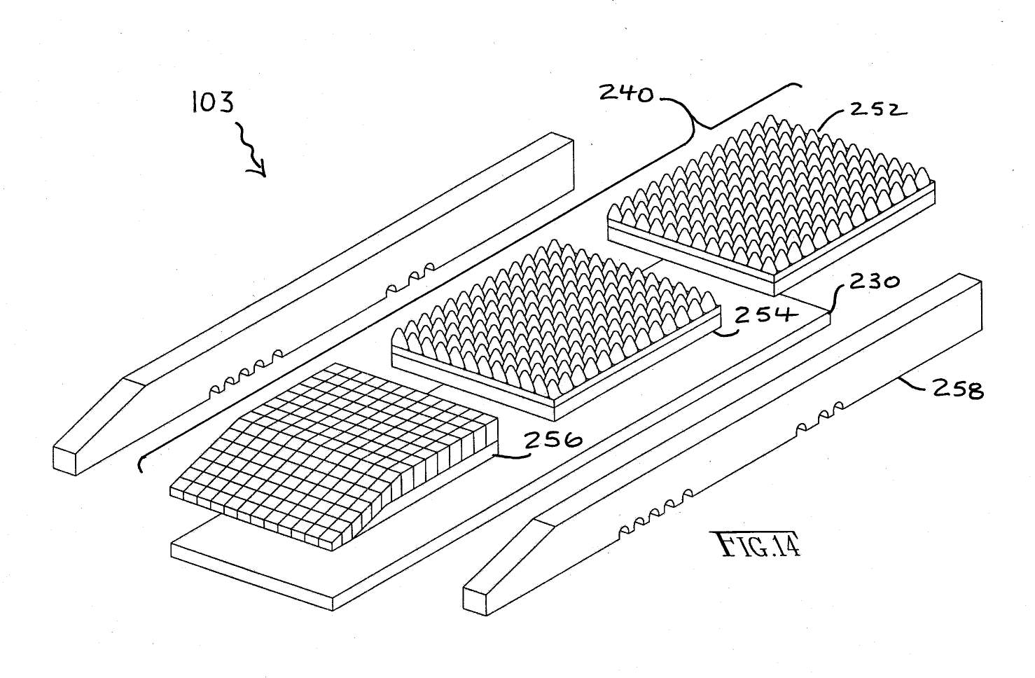

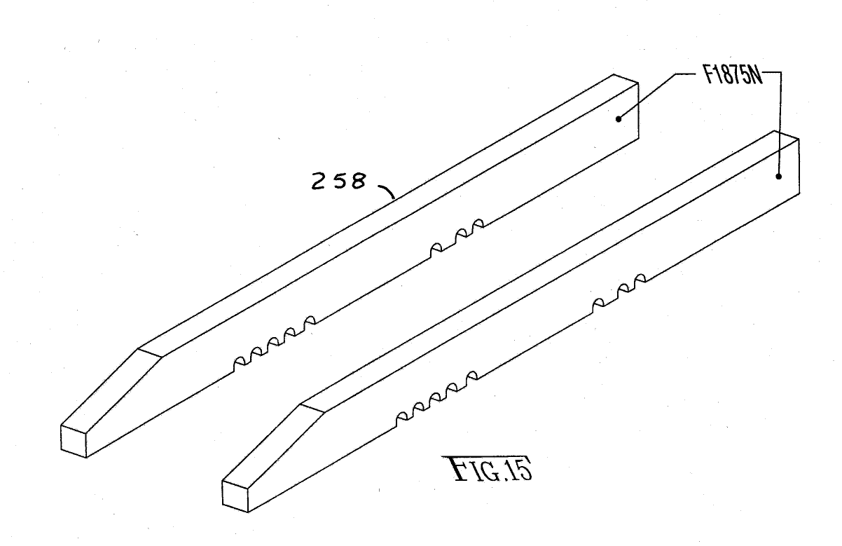

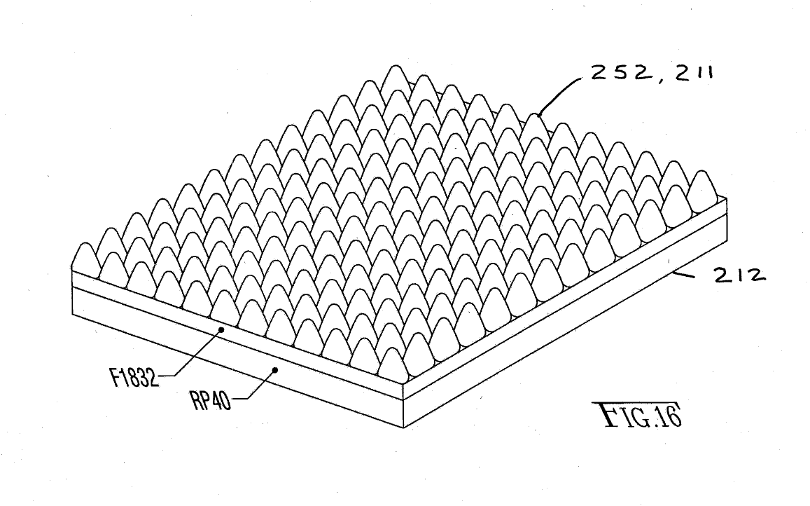

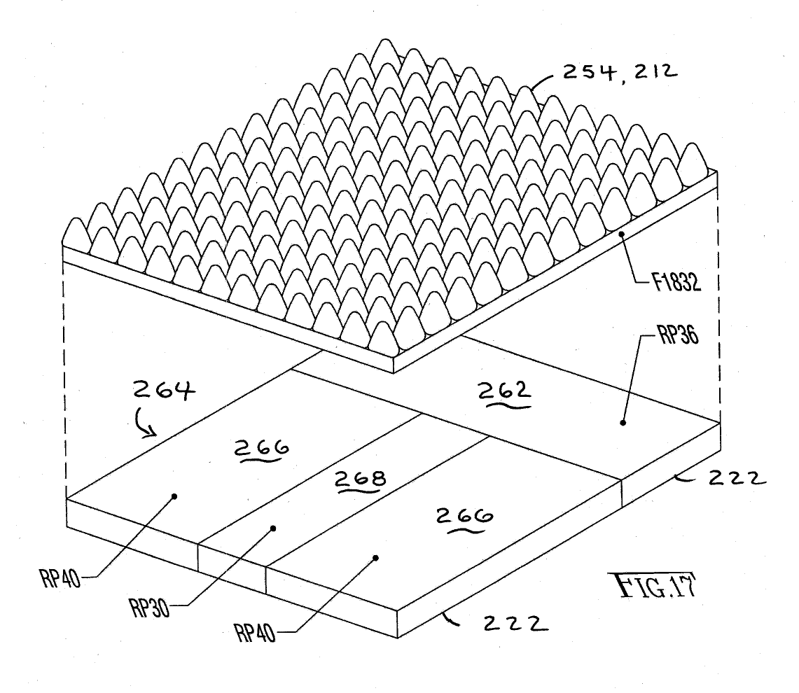

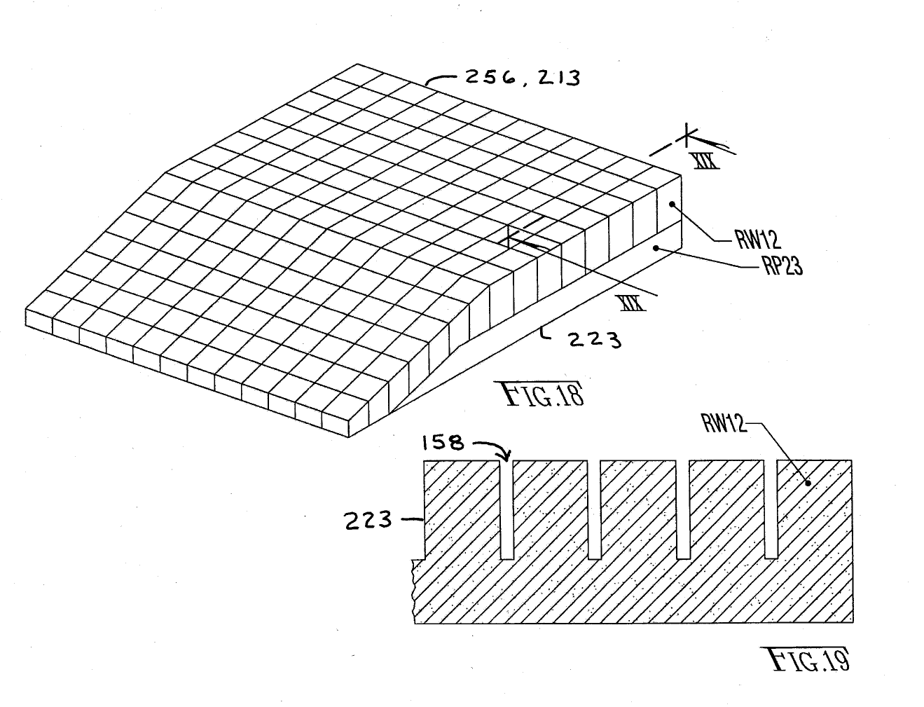

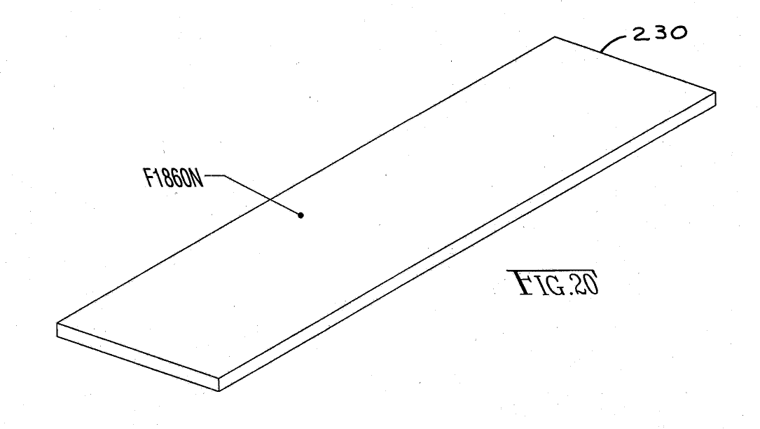

To turn to FIGS. 12 though 20, these views show a third embodiment 103 of a cushioning construction in accordance with the invention, as adapted to serve as a bed mattress. In FIG. 12, only a portion of the encasement member therefor is shown in solid line (and is not shown at all in any of the other views).

Such a cushioning construction 103 as adapted for a bed mattress preferably includes the following. There is an upper layer 211-213 of resilient material formed in a generally rectangular outline, an underlying lower layer 221-223 of resilient material also formed in a generally rectangular outline and underlying as well as underneath the upper layer 211-213, and an underlying base layer 230 of resilient material also formed in a generally rectangular outline as well as underlying and underneath the lower layer 221-223. Wherein the upper and lower layers 211-213 and 221-223 would generally be coextensive with one another and cooperatively form a core assembly 240 for said cushioning construction 103. Also, the core assembly 240 is partitioned into longitudinal zones comprising a forward upper body support zone 252, an intermediate pelvic-and-upper thigh support zone 254, and a rearward lower extremity support zone 256.

This cushioning construction for a bed mattress further includes a pair of side rails 258 of resilient material configured to rest upon or rest against the outer lateral margins of the base layer 230 and flank the core assembly 240. Wherein the side rails 258 are preferably firmer (considerably firmer) than the base layer 230, and the base layer 230 is preferably firmer than any part of the core assembly 240. Moreover, preferably the lower layer 223 of the lower extremity support zone 256 is firmer than the upper layer 213 of the lower extremity support zone 256. Additionally, preferably both the upper and lower layers 213 and 223 of the lower extremity support zone 256 are softer than any part of either the upper body support zone 211/221/252 and/or the pelvic-and-upper thigh support zone 212/222/254. And preferably further still, the lower layer 211 of the upper body support zone 252 is preferably firmer than the upper layer 212 of the upper body support zone 252.

To turn now to particulars of the pelvic-and-upper thigh support zone 254, it is further partitioned into longitudinal zones comprising a forward pelvic support sub-zone 262 and a rearward upper thigh support sub-zone 264. The latter, this upper thigh support sub-zone 264, it is further partitioned into at least two outer longitudinally-elongated blocks 266 of resilient material and at least one inner longitudinally-elongated block 268 of resilient material medial of the at least two outer blocks 266. It is a design preference for the invention that the at least two outer longitudinally-elongated blocks 266 are preferably firmer than at least one inner longitudinally-elongated block 268.

It is a further design preference for the invention that the upper layer 212 of the pelvic-and-upper thigh support zone 254 comprises a unitary slab of resilient material. That way, the pelvic support sub-zone 262 as well as the upper thigh support sub-zone 262, along with the at least two outer longitudinally-elongated blocks 266 and at least one inner longitudinally-elongated block 268 thereof, are all partitioned out of the lower layer 222 of the pelvic-and-upper thigh support zone 254 (and not the upper layer 212, which is consequently preferably comprised of a single slab of foam). It is moreover still another aspect of the invention that the pelvic support sub-zone 262 is preferably softer than at least two outer longitudinally-elongated blocks 266 of the upper thigh support sub-zone 264.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

What is claimed is:

1. A cushioning construction adapted for draping over a chair that has armrests, comprising:
a seat support section comprising a resilient material formed in a generally rectangular outline; and
a back support section comprising a resilient material formed in a generally rectangular outline.

2. The cushioning construction of claim 1 wherein:
the back support section is formed by at least two outer vertically-elongated blocks of resilient material and at least one inner vertically-elongated block of resilient material medial of the at least two outer blocks;
a flexible encasement member for the back support section configured with at least one pocket adapted for receiving the at least two outer blocks and also the at least one inner vertically elongated block;
said flexible encasement member further comprising vertically-elongated seams intermediate the blocks which not only serve to stabilize positions among the blocks but also define articulation axes between adjacent blocks whereby the blocks can articulate relative to each other about the axes.

3. The cushioning construction of claim 2 wherein:
said blocks of the back support section are cooperatively formed to form a shallow, vertically-extending channel shape into the depth of the back support section, whereby the at least one inner block is adapted to serve as a spinal support block for the seat occupant and the at least two outer blocks are adapted to provide moderately enveloping lateral wings to support the torso of the seat occupant.

4. The cushioning construction of claim 3 wherein:
said at least two outer vertically-elongated blocks of resilient material are formed as composites of a major portion of one resilient material having one set of properties and a hip support portion of another resilient material having a another set of properties; and
the hip support portions of the other resilient material for both the at least two outer vertically-elongated blocks are located down low in the back support section and flanking the seat occupant's hips;
said other resilient foam material of the hip support portions being softer than the one resilient foam material of the major portions.

5. The cushioning construction of claim 1 further comprising:
a left and a right flexible linking substrate;
a left-side and a right-side plurality of longitudinally-elongated slats of resilient materials flexibly linked together by the left and right flexible linking substrates, respectively, and thereby adapted to form a roll over the chair's left and right armrests, respectively; and
a flexible encasement member for both the seat support section and the left-side and right-side plurality of longitudinally-elongated slats;
wherein said flexible encasement member is configured with a seat support-section pocket adapted for receiving the seat support section and also with a left-side flap and a right-side flap, each flap being configured with a pocket adapted for receiving the left-side and right-side plurality of longitudinally-elongated slats, respectively; and
wherein said flexible encasement member further comprises a series of longitudinally-extending seams intermediate the pockets, whereby the seams not only serve as partitions between the pockets for the seat support section as well as the left-side and right-side flaps but also define longitudinally-extending articulation axes therebetween such that the flaps and seat support section can articulate relative to each other.

6. The cushioning construction of claim 5 wherein:
said flexible encasement member is further configured with a back support-section pocket adapted for receiving the back support section;
said flexible encasement member further comprising a laterally-extending seam intermediate the seat support-section pocket and the back support-section pocket whereby the laterally-extending seam not only serves as a partition between the pockets for the seat support section and the back support section but also defines a laterally-extending articulation axis therebetween whereby said support sections can articulate relative to each other about said laterally-extending articulation axis.

7. The cushioning construction of claim 6 further comprising:
a lower limb support section comprising a resilient material formed in a generally rectangular outline;
wherein said flexible encasement member is further configured with a lower limb support-section pocket adapted for receiving the lower limb support section;
said flexible encasement member further comprising a second laterally-extending seam intermediate the seat support-section pocket and the lower limb support-section pocket whereby the second laterally-extending seam not only serves as a partition in part between the pockets for the seat support section and the lower limb support section but also defines a second laterally-extending articulation axis therebetween whereby said support sections can articulate relative to each other about said second laterally-extending articulation axis.

8. The cushioning construction of claim 7 wherein:
the seat support section and the lower limb support section have upper surfaces covered by the encasement member in part; and
one or both of the upper surfaces of the seat support section and/or the lower limb support section are configured with at least laterally-trending, air ventilation channels.

9. The cushioning construction of claim 7 wherein:
the lower limb support section comprises a block of resilient material at least wedge-shaped in part, and extending longitudinally between a proximal end proximate the seat support section and a spaced away distal end; and
the lower limb support section generally tapers thinner from the proximal end, which is relatively thicker, to the distal end, which is relatively thinner.

10. The cushioning construction of claim 1 further comprising:
a lower limb support section comprising a resilient material formed in a generally rectangular outline; and
a flexible encasement member for all of seat support section, the back support section, and the lower limb support section;
wherein said flexible encasement member is configured with a back support-section pocket adapted for receiving the back support section, a seat support-section pocket adapted for receiving the seat support section, and a lower limb support-section pocket adapted for receiving the lower limb support section;
said flexible encasement member further comprising laterally-extending seams intermediate the pockets at least in part whereby the laterally-extending seams not only serve as partitions in part between the pockets for the support sections but also define laterally-extending articulation axes therebetween whereby said support sections can articulate relative to each other about said laterally-extending articulation axes.

11. The cushioning construction of claim 10 wherein:
the seat support section comprises a seat-section upper layer of resilient material and an underlying lower layer of resilient material underneath the seat-section upper layer;
the lower limb support section comprises a lower-limb section upper layer of resilient material and a continuation of the lower layer of resilient material for the seat-section upper layer, underlying and underneath the lower limb-section upper lower;
wherein said lower layer is firmer than both the upper layers.

12. The cushioning construction of claim 10 wherein:
the lower limb support section comprises a block of resilient material at least wedge-shaped in part, and extending longitudinally between a proximal end proximate the seat support section and a spaced away distal end; and
the lower limb support section generally tapers thinner from the proximal end, which is relatively thicker, to the distal end, which is relatively thinner.

13. The cushioning construction of claim 1 wherein:
the back support section comprises at least one block of one resilient material or plural block of said one or plural resilient materials, which is or are arranged such said at least one block or all blocks form the generally rectangular outline for a major part of said back support section;
said back support section further comprising a lumbar support cushion of another resilient material arranged on the occupant-side outside of the at least one block or all blocks of the one or plural resilient materials that form the generally rectangular outline for the major part of said back support section;
said other resilient material of the lumbar support cushion being softer than the one or plural resilient materials for any of the at least one block or all blocks of the major part of said back support section.

14. The cushioning construction of claim 1 wherein:
the seat support section comprises an upper layer of resilient material and an underlying lower layer of resilient material underneath the upper layer;
wherein said lower layer is firmer than the upper layer.

15. The cushioning construction of claim 14 wherein:
the upper layer is partitioned into longitudinal zones comprising a forward femoral support zone of non-viscoelastic memory foam and a rearward ischium support zone of viscoelastic memory foam.

16. The cushioning construction of claim 15 wherein:
said forward femoral support zone further comprises a low-rising, laterally-extending femoral support cushion of another resilient material;
wherein the forward femoral support zone is firmer than the low-rising, laterally-extending femoral support cushion.

17. The cushioning construction of claim 16 wherein:
said forward femoral support zone comprises a block of resilient material at least wedge-shaped in part, and extending longitudinally between a proximal end proximate the ischium support zone and a spaced away distal end; and
said forward femoral support zone generally tapers thinner from the proximal end, which is relatively thicker, to the distal end, which is relatively thinner.

18. The cushioning construction of claim 15 wherein:
the seat support section further comprises a base layer of a rigid material, underlying and underneath the lower layer of resilient material for the seat support section.

19. A cushioning construction adapted as medical mattress for a bed, comprising:
an upper layer of resilient material formed in a generally rectangular outline, an underlying lower layer of resilient material also formed in a generally rectangular outline and underlying as well as underneath the upper layer, and an underlying base layer of resilient material also formed in a generally rectangular outline as well as underlying and underneath the lower layer;
wherein the upper and lower layers are generally coextensive with one another and cooperatively form a core assembly for said cushioning construction;
said core assembly being partitioned into longitudinal zones comprising a forward upper body support zone, an intermediate pelvic-and-upper thigh support zone, and a rearward lower extremity support zone.

20. The cushioning construction of claim 19 further comprising:
a pair of side rails of resilient material configured to rest upon or rest against the outer lateral margins of the base layer and flank the core assembly;
wherein the rails are firmer than the base layer, and the base layer is firmer than any part of the core assembly.

21. The cushioning construction of claim 19 wherein:
the lower layer of the lower extremity support zone is firmer than the upper layer of the lower extremity support zone; and
both the upper and lower layers of the lower extremity support zone are softer than any part of either the upper body support zone and/or the pelvic-and-upper thigh support zone.

22. The cushioning construction of claim 21 wherein:
the lower layer of the upper body support zone is firmer than the upper layer of the upper body support zone.

23. The cushioning construction of claim 19 wherein:
the pelvic-and-upper thigh support zone is further partitioned into longitudinal zones comprising a forward pelvic support sub-zone and a rearward upper thigh support sub-zone; and
the upper thigh support sub-zone is further partitioned into at least two outer longitudinally-elongated blocks of resilient material and at least one inner longitudinally-elongated block of resilient material medial of the at least two outer blocks;
wherein at least two outer longitudinally-elongated blocks are firmer than at least one inner longitudinally-elongated block.

24. The cushioning construction of claim 23 wherein:
the upper layer of the pelvic-and-upper thigh support zone comprises a unitary slab of resilient material, whereby the pelvic support sub-zone as well as the upper thigh support sub-zone, along with the at least two outer longitudinally-elongated blocks and at least one inner longitudinally-elongated block thereof, are all partitioned out of the lower layer of the pelvic-and-upper thigh support zone.

25. The cushioning construction of claim 23 wherein:
the pelvic support sub-zone is softer than at least two outer longitudinally-elongated blocks of the upper thigh support sub-zone.
